(19) United States
(12) Patent Application Publication
(10) Pub. No.: US 2026/0147895 A1
(43) Pub. Date: May 28, 2026

(54) ELECTRONIC DEVICE AND SECURE BOOT METHOD USING THE SAME

(71) Applicants: Sercomm Corporation, Taipei City (TW); Sernet (Suzhou) Technologies Corporation, Jiangsu (CN)

(72) Inventor: ShaoHai ZHAO, Jiangsu (CN)

(21) Appl. No.: 19/339,429

(22) Filed: Sep. 25, 2025

(30) Foreign Application Priority Data
Nov. 26, 2024 (CN) 202411707115.4

(51) Int. Cl. G06F 21/57

(52) U.S. Cl. CPC G06F 21/575; G06F 2221/034

(57) ABSTRACT

An electronic device includes a storage unit and a processor. The storage unit is used to store an operating system kernel partition of an operating system. The processor is used to: verify whether a inspected portion of the operating system kernel partition is secure; if the inspected portion of the operating system kernel partition is secure, start the application layer of the operating system; verify whether the remaining portion of the operating system kernel partition is secure; and, if the remaining portion of the operating system kernel partition is unsecure, issue a warning message. Compared to performing a security verification on all multiple partitions of the operating system before activating the application layer of the operating system, the secure boot method of an embodiment of the present invention may reduce boot time while ensuring boot security.

This application claims the benefit of People's Republic of China application Serial No. 202411707115.4, filed on Nov. 26, 2024, the subject matter of which is incorporated herein by reference.

### BACKGROUND OF THE INVENTION

### Field of the Invention

The invention relates in general to an electronic device and a secure boot method using the same.

### Description of the Related Art

With the widespread use of an electronic device such as a computer, etc., consumers have become accustomed to storing a wide variety of data on the electronic device. Consequently, information security has become a growing concern for consumers. The increasing prevalence of malware and Trojans program has significantly increased the chances of the electronic device being hacked, making stored data increasingly vulnerable to theft. Therefore, implementing security verification during the boot process has become a key goal for industry professionals.

### SUMMARY OF THE INVENTION

According to an embodiment of the present invention, an electronic device is provided. The electronic device includes a storage unit and a processor. The storage unit is configured to store an operating system kernel partition of an operating system. The processor is configured to: verify whether an inspected portion of the operating system kernel partition is secure; if the inspected portion of the operating system kernel partition is secure, activate an application layer of the operating system; verify whether a remaining portion of the operating system kernel partition is secure; and if the remaining portion of the operating system kernel partition is unsecure, issue a warning message.

According to another embodiment of the present invention, a secure boot method of an electronic device is provided. The secure boot method includes the following steps: verifying, by a processor of the electronic device, whether an inspected portion of an operating system kernel partition is secure; if the inspected portion of the operating system kernel partition is secure, activating, by the processor, an application layer of the operating system; verifying, by the processor, whether a remaining portion of the operating system kernel partition is secure; and if the remaining portion of the operating system kernel partition is unsecure, issuing, by the processor, a warning message.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A illustrates a functional block diagram of an electronic device according to an embodiment of the present invention;

FIG. 1B illustrates a schematic diagram of a configuration of an operating system kernel partition in FIG. 1A within a storage unit;

FIG. 2 illustrates a flow chart of a secure boot method for the electronic device in FIG. 1; and

FIG. 3 illustrates a flow chart of another secure boot method for the electronic device in FIG. 1.

### DETAILED DESCRIPTION OF THE INVENTION

The following describes various embodiments of the present invention in detail, with accompanying drawings as examples. In addition to these detailed descriptions, the present invention may also be widely implemented in other embodiments. Any easy substitution, modification, and equivalent variation of any of the described embodiments are included within the scope of the present invention and are subject to the claims of the present invention. In the description of the specification, many specific details and implementation examples are provided to provide the reader with a more complete understanding of the present invention; however, these specific details and implementation examples should not be construed as limitations of the present invention. In addition, well-known steps or components are not described in detail to avoid unnecessary limitations of the present invention.

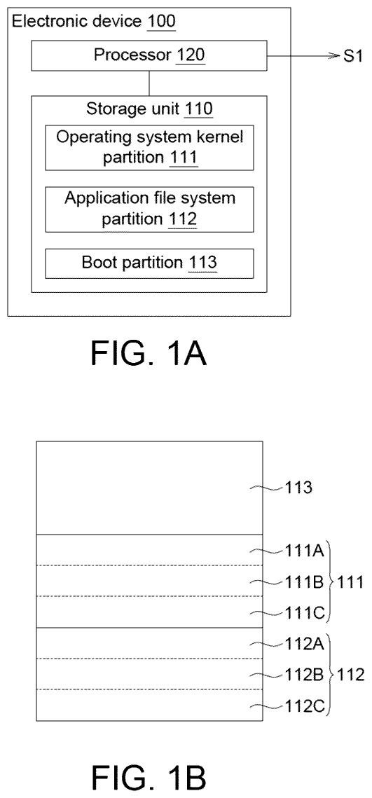

Referring to FIGS. 1A and 1B, FIG. 1A illustrates a functional block diagram of an electronic device 100 according to an embodiment of the present invention, and FIG. 1B illustrates a schematic diagram of a configuration of an operating system kernel partition 111 in FIG. 1A within a storage unit 110. The electronic device 100 may be, for example, a notebook computer, a tablet computer, a desktop computer or a handheld device (for example, a smartphone).

As illustrated in FIGS. 1A and 1B, the electronic device 100 includes the storage unit 110 and a processor 120. The storage unit 110 stores the operating system kernel partition 111. The processor 120 is configured to: verify the security of an inspected portion of the operating system kernel partition 111; if the inspected portion is secure, activate an application layer of the operating system; verify whether the remaining portion of the operating system kernel partition 111 is secure; and issue a warning message S1 if the remaining portion is unsecure. In the present embodiment, the electronic device 100 first performs a first security verification on the operating system kernel partition 111. If the first security verification passes (for example, indicating that the data has not been tampered with), a second security verification is performed on the operating system kernel partition 111 at the same time while the application layer of the operating system is activated. Compared to performing a security verification on the entire operating system kernel partition 111 before launching the application layer of the operating system, the secure boot method of the present embodiment of the present invention may reduce boot time (accelerate boot time) while also ensuring boot security.

An operating system (OS) is a set of interrelated system software programs that manage and control computer operations, utilize and execute hardware and software resources and provide public services to organize user interactions. It is also the core and foundation of a computer system. The operating system handles basic tasks such as managing and configuring main memory, determining the priority of system resource supply and demand, controlling input and output devices, operating the network, and managing the file system. The operating system also provides an interface for users to interact with the system. Specifically, the operating system includes Windows, Linux, etc.

The storage unit 110 is, for example, a memory or hard disk, which may include a plurality of blocks. The block capacity is, for example, the minimum storage capacity of the storage unit 110, such as 512 KB. Depending on the type of operating system and/or the formatting parameters of storage unit 110, the block capacity may be other values. The operating system may be stored in these blocks of the storage unit 110. For example, the operating system kernel partition 111 occupies a plurality of the blocks of the storage unit 120, with the inspected portion of operating system kernel partition 111 occupying one or some of the blocks, while the remaining portion of the operating system kernel partition 111 occupies the remaining ones (for example, the other or the others) of the blocks.

The processor 120 is, for example, a central processing unit (CPU).

As illustrated in FIGS. 1A and 1B, the processor 120 may verify a front segment 111A, a middle segment 111B and back segment 111C of the operating system kernel partition 111. Here, the inspected portion (the first security verification) of the operating system kernel partition 111 may be one or some of the front segment 111A, the middle segment 111B and the back segment 111C, while the remaining portion (the first security verification) of the operating system kernel partition 111 may be the others of the front segment 111A, the middle segment 111B and the back segment 111C. For example, the inspected portion of the operating system kernel partition 111 may be the portion of the operating system kernel partition 111 that is most susceptible or relatively susceptible to hacker tampering, for example, the front segment 111A and/or the back segment 111C, but this embodiment of the present invention is not limited thereto.

As illustrated in FIGS. 1A and 1B, the storage unit 110 further includes an application file system partition 112 and a boot partition 113. The processor 120 is configured to: determine whether the inspected portion of the application file system partition 112 is secure; if the inspected portion of the application file system partition 112 and the operating system kernel partition 111 is secure, activate the application layer of the operating system (for example, the processor 120 loads or executes at least one application); verify whether the remaining portion of the application file system partition 112 is secure; and issue the warning message S1 if the remaining portion of the application file system partition 112 is unsecure. In the present embodiment, the electronic device 100 first performs the first security verification on the application file system partition 112 of the operating system. If the first security verification passes (for example, indicating that the data has not been tampered with), the second security verification is performed on the application file system partition 112 while at the same time activating the application layer of the operating system. Compared to performing a security verification on the entire application file system partition 112 before activating the application layer, the secure boot method of the present embodiment of the present invention may reduce boot time (that is, faster boot) while maintaining boot security.

The application file system partition 112 occupies a plurality of the blocks of the storage unit 120. The inspected portion (the first security verification) of the application file system partition 112 is one or some of the blocks, while the remaining portion of the application file system partition 112 (the second security verification is the others of the blocks.

As illustrated in FIGS. 1A and 1B, the processor 120 may verify a plurality of the front segments 112A, the middle segments 112B and back segments 112C of the application file system partition 112. The inspected portion of the application file system partition 112 may be one or some of the front segment 112A, the middle segment 112B and the back segment 112C. For example, the inspected portion of the application file system partition 112 may be the portion of the application file system partition 112 that is most vulnerable or more susceptible to hacker tampering, for example, the front segment 112A and/or the back segment 112C; however, this is not a limitation of the present invention.

In an embodiment, the processor 120 may first load the boot code from the boot partition 113. The boot code is configured to execute: program codes of the operating system kernel partition 111 and program codes of the application file system partition 112, wherein the processor 120 first performs the security verification on the inspected portion of the operating system kernel partition 111 before executing program codes of the operating system kernel partition 111, the processor 120 first performs the security verification on the inspected portion of the application file system partition 112 before executing program codes of the application file system partition 112, and the processor 120 then performs the security verification on the remaining portions of the operating system kernel partition 111 and the remaining portions of the application file system partition 112 when activating the application layer of the operating system.

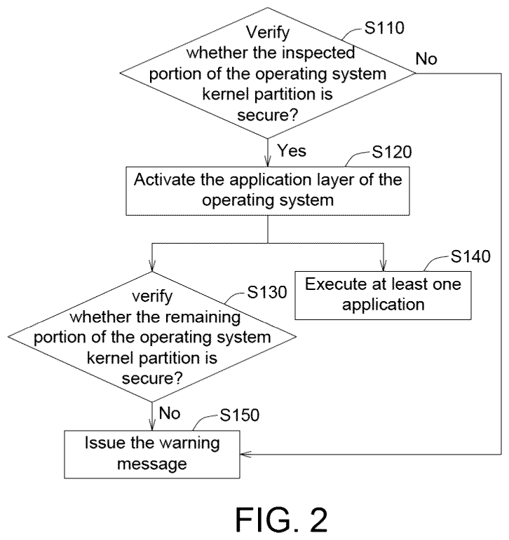

Referring to FIG. 2, FIG. 2 illustrates a flow chart of a secure boot method for the electronic device 100 in FIG. 1.

In step S110, in response to a user boot command, the processor 120 may verify whether the inspected portion of the operating system kernel partition 111 is secure. For example, the processor 120 may verify whether the inspected portion of the operating system kernel partition 111 has been tampered with and/or does not conform to pre-set content. If the inspected portion is secure, it indicates that no abnormality and/or no tampering were found in the data of the inspected portion of the operating system kernel partition 111, the process proceeds to step S120. If the inspected portion is unsecure, it indicates that the abnormality and/or tampering were found in the data of the inspected portion of the operating system kernel partition 111, the process proceeds to step S150, and the processor 120 issues the warning message S1.

The aforementioned user boot command is generated, for example, by the user pressing a power button or a boot button of the electronic device 100. In addition, the warning message may be displayed on a screen of the electronic device 100, and the warning message S1 may be a text window. In another embodiment, the warning message may be a sound which may be emitted by a speaker of the electronic device 100. In an embodiment, the processor 120 may pause the boot process while issuing the warning message S1, and resume the boot process until the user inputs a resume boot command. In another embodiment, the processor 120 may continue the boot process while issuing the warning message S1, unless the user inputs a pause boot command.

In step S120, processor 120 activates the application layer of the operating system. The processor 120 then executes steps S130 and S140.

In step S130, processor 120 verifies whether the remaining portion of the operating system kernel partition 111 is secure. If so, it indicates that no abnormality and/or no tampering have been found in the data in the remaining portion of the operating system kernel partition 111 (or the data in the remaining portion of the operating system kernel partition 111 is free of the abnormality and/or the tampering), and the boot process continues. If not, it indicates that the abnormality and/or the tampering have been found in the data in the remaining portion of the operating system kernel partition 111, and the process proceeds to step S150, and the processor 120 issues the warning message S1.

In step S140, the processor 120 executes at least one application. In the present embodiment, while executing an application, the processor 120 may perform the security verification on the remaining portion of the operating system kernel partition 111. In another embodiment, the processor 120 may first perform the security verification on the remaining portion of the operating system kernel partition 111, and execute the application after the remaining portion of the operating system kernel partition 111 passes the security verification.

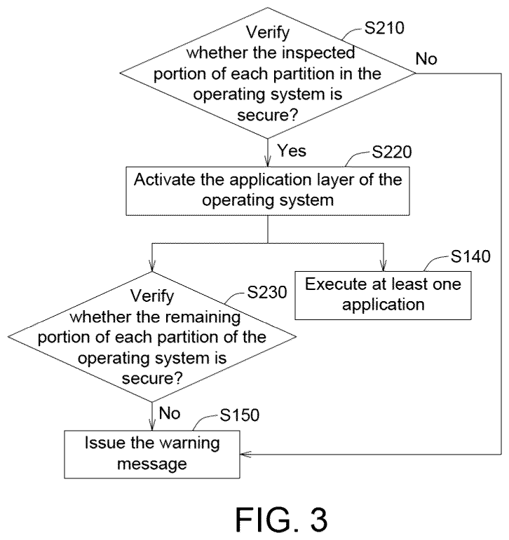

Referring to FIG. 3, FIG. 3 illustrates a flow chart of another secure boot method for the electronic device 100 in FIG. 1.

In step S210, in response to the user boot command, the processor 120 may verify whether the inspected portion of each partition in the operating system is secure. If so, it indicates that that no abnormality and/or no tampering have been found in the data in the inspected portion of each partition, and the process proceeds to step S220. If not, it indicates that the abnormality and/or the tampering have been found in the data in the inspected portion of each partition, the process proceeds to step S150, and the processor 120 issues the warning message S1.

For example, the processor 120 may verify wherever the inspected portions of the operating system kernel partition 111 is secure and whether the inspected portions of the application file system partition 112 is secure. If both the inspected portion of the operating system kernel partition 111 and the inspected portion of the application file system partition 112 pass the security verification, the process proceeds to step S220. If either the inspected portion of the operating system kernel partition 111 or the inspected portion of the application file system partition 112 fails the security verification, it indicates that the abnormality and/or the tampering were found in the data in at least one of the inspected portion of the operating system kernel partition 111 and the inspected portion of the application file system partition 112, the process proceeds to step S150, and the processor 120 issues the warning message S1.

In step S220, the processor 120 activates the application layer of the operating system. Then, the processor 120 executes steps S230 and S140.

In step S230, the processor 120 verifies whether the remaining portion of each partition of the operating system is secure. If so, the boot process continues. If not, it indicates that the abnormality and/or the tampering were found in the data in the remaining portion of at least one of the partitions, the process proceeds to step S150, and the processor 120 issues the warning message S1.

For example, the processor 120 may verify whether the remaining portion of the operating system kernel partition 111 and the remaining portion of the application file system partition 112 are secure. If both the remaining portion of the operating system kernel partition 111 and the remaining portion of the application file system partition 112 pass the security verification, the processor 120 continues the boot process. If either the remaining portion of the operating system kernel partition 111 or the remaining portion of the application file system partition 112 fails the security verification, it indicates that the abnormality and/or the tampering were found in the data in at least one of the remaining portion of the operating system kernel partition 111 and the remaining portion of the application file system partition 112, the process proceeds to step S150, and the processor 120 issues the warning message S1.

In step S140, the processor 120 executes at least one application. In the present embodiment, while executing the application, the processor 120 may perform the security verification on the remaining portion of the operating system kernel partition 111 and the remaining portion of the application file system partition 112. In another embodiment, the processor 120 may first perform the security verification on the remaining portion of the operating system kernel partition 111 and the remaining portion of the application file system partition 112, and execute the application after each partition passes the security verification.

In summary, the electronic device 100 first performs the security verification (the first security verification) on a portion (for example, the inspected portion) of at least one of a plurality of the partitions in the operating system. If the first security verification passes (for example, indicating that no abnormality is found in the data of the inspected portion and/or that it has not been tampered with), the security verification (the second security verification) is performed on the remaining portion of at least one of the partitions in the operating system at the same time, before or after activating the application layer of the operating system. Compared to performing the security verification on all of the partitions of the operating system before activating the application layer of the operating system, the secure boot method of the embodiment of the present invention may reduce the boot time (quick boot) while taking into account boot security.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An electronic device, comprising:
a storage unit, configured to store an operating system kernel partition of an operating system; and
a processor, configured to:
verify whether an inspected portion of the operating system kernel partition is secure;
if the inspected portion of the operating system kernel partition is secure, activate an application layer of the operating system;
verify whether a remaining portion of the operating system kernel partition is secure; and
if the remaining portion of the operating system kernel partition is unsecure, issue a warning message.

2. The electronic device of claim 1, wherein the storage unit is further configured to store an application file system partition; and the processor is further configured to:
verify whether the inspected portion of the application file system partition is secure;
if the inspected portion of the application file system partition is secure, activate the application layer of the operating system;
verify whether a remaining portion of the application file system partition is secure; and
if the remaining portion of the application file system partition is unsecure, issue the warning message.

3. The electronic device of claim 1, wherein the inspected portion of the operating system kernel partition is stored in a portion of a plurality of blocks in the storage unit, and the remaining portion of the operating system kernel partition is stored in a remaining portion of the blocks in the storage unit.

4. The electronic device of claim 3, wherein a capacity of each of the blocks is a minimum storage capacity of the storage unit.

5. The electronic device of claim 1, wherein the inspected portion of the operating system kernel partition is at least one of a front segment and a back segment of the operating system kernel partition.

6. A secure boot method of an electronic device, comprising:
verifying, by a processor of the electronic device, whether an inspected portion of an operating system kernel partition is secure;
if the inspected portion of the operating system kernel partition is secure, activating, by the processor, an application layer of the operating system;
verifying, by the processor, whether a remaining portion of the operating system kernel partition is secure; and
if the remaining portion of the operating system kernel partition is unsecure, issuing, by the processor, a warning message.

7. The secure boot method of claim 6, further comprising:
verifying, by the processor, whether the inspected portion of the application file system partition is secure;
if the inspected portion of the application file system partition is secure, activating, by the processor, the application layer of the operating system;
verifying, by the processor, whether a remaining portion of the application file system partition is secure; and
if the remaining portion of the application file system partition is unsecure, issuing, by the processor, the warning message.

8. The secure boot method of claim 6, wherein the inspected portion of the operating system kernel partition is stored in a portion of a plurality of blocks in the storage unit, and the remaining portion of the operating system kernel partition is stored in a remaining portion of the blocks in the storage unit.

9. The secure boot method of claim 8, wherein a capacity of each of the blocks is a minimum storage capacity of the storage unit.

10. The secure boot method of claim 6, wherein the inspected portion of the operating system kernel partition is at least one of a front segment and a back segment of the operating system kernel partition.
